(19) United States
(12) Patent Application Publication
(10) Pub. No.: US 2014/0015486 A1
(43) Pub. Date: Jan. 16, 2014

(54) VEHICLE CHARGING DEVICE

(71) Applicant: Tsuyoshi Nishio, Kanagawa (JP)

(72) Inventor: Tsuyoshi Nishio, Kanagawa (JP)

(73) Assignee: PANASONIC CORPORATION, Osaka (JP)

(21) Appl. No.: 14/008,225

(22) PCT Filed: Mar. 29, 2012
(86) PCT No.: PCT/JP2012/002197

§ 371 Date: Sep. 27, 2013

(30) Foreign Application Priority Data
Mar. 30, 2011 (JP) 2011-076124

(51) Int. Cl. B60L 11/18

(52) U.S. Cl. CPC B60L 11/18
USPC 320/109

(57) ABSTRACT

Provided is a vehicle charging device vehicle charging device (170) that charges a battery (115) installed in a vehicle (160) from a power source (101) which is outside the vehicle (160). The charger (114) is connected to the external power source (101), and uses a variable input current for charging the battery (115). A control unit (113): changes the input currents of the charger (114) into a plurality of values, and determines lower thresholds for the appropriate ranges of the input current and the input voltage, according to the corresponding relationship between the input currents, when each has been changed, and the input voltages measured by a voltage measurement unit (111); and controls the input current when the input voltage has changed, according to the corresponding relationship and the lower thresholds, after charging has started.

### TECHNICAL FIELD

The present invention relates to an in-vehicle charging apparatus configured to charge a storage battery serving as the power source of a vehicle such as an electric vehicle, using a power supply of a house, for example.

### BACKGROUND ART

In recent years, charging of storage batteries installed in a vehicle such as an electric vehicle using a power supply of house (house of the owner of the vehicle) has been in practice. Since the power supply of a house supplies power to various electric devices such as an air conditioner, an overcurrent flowing through a power supply circuit may be caused by, for example, an increase in the number of electric devices in use. When an overcurrent occurs, the power supply circuit is shut off to stop supply of the power to the electric devices, thus making all the electric devices temporarily unusable.

Conventionally, electric device systems configured to reduce a current amount according to a decrease in a receiving voltage have been known as a method of preventing an overcurrent flowing through a power supply circuit in a house (for example, Patent Literature (hereinafter, abbreviated as PTL) 1). In an electric device system of PTL 1, when a decrease in a receiving voltage is detected by a voltage detector, a current amount in the entire system is reduced by controlling a power converter according to this decrease.

### CITATION LIST

### Patent Literature

PTL 1

Japanese Patent Application Laid-Open No. 2003-92829

### SUMMARY OF INVENTION

### Technical Problem

The system apparatus according to PTL 1, however, reduces a current amount of the system without taking into consideration the fluctuation range of the output voltage of a power source. As a result, when the output voltage of the power source decreases even if the current amount is reduced, a load exceeding power source supply capacity is given to a power supply circuit. As a result, there arises a problem in that charge cannot be performed because the power supply circuit is shut off, and all the electric devices become temporarily unusable.

It is an object of the present invention to provide an in-vehicle charging apparatus capable of preventing an in-vehicle charger from becoming unable to perform charge and also preventing an unusable state of another electric device in a house or the like by controlling the input current of the in-vehicle charger in consideration of the fluctuation range of the output voltage of the power source.

### Solution to Problem

An in-vehicle charging apparatus according to an aspect of the present invention charges a storage battery installed in a vehicle from a power source provided outside the vehicle, the apparatus including: a charger that is connected to the power source provided outside the vehicle and that receives a variable input current for charging the storage battery; a measurement section that measures the input current of the charger and an input voltage corresponding to the input current; and a control section that varies the input current of the charger into a plurality of values, determines a lower limit threshold of a proper range of the input current and the input voltage according to a correspondence between the input currents during the varying and the input voltages measured by the measurement section, and controls the input current according to the correspondence and the lower limit threshold when the input voltage varies after start of charge.

### Advantageous Effects of Invention

According to the present invention, is possible to prevent an in-vehicle charger from becoming unable to perform charge and also to prevent an unusable state of another electric device in a house or the like by controlling the input current of the in-vehicle charger in consideration of the fluctuation range of the output voltage of the power source.

### BRIEF DESCRIPTION OF DRAWINGS

FIG. 1 illustrates a configuration of a charging system according to an embodiment of the present invention;

FIG. 2 illustrates a first method of determining a lower limit threshold according to the embodiment of the present invention;

FIG. 3 illustrates a second method of determining a lower limit threshold according to the embodiment of the present invention;

FIG. 4 illustrates a third method of determining a lower limit threshold according to the embodiment of the present invention;

FIG. 5 illustrates a fourth method of determining a lower limit threshold according to the embodiment of the present invention;

FIG. 6 illustrates a fifth method of determining a lower limit threshold according to the embodiment of the present invention;

FIG. 7 illustrates an example of a sixth method of determining a lower limit threshold according to the embodiment of the present invention;

FIG. 8 illustrates another example of the sixth method of determining a lower limit threshold according to the embodiment of the present invention;

FIG. 9 illustrates a method of finding the amount of variation in the input voltage measured by a voltage measurement section according to the embodiment of the present invention;

FIG. 10 illustrates a seventh method of determining a lower limit threshold according to the embodiment of the present invention;

FIG. 11 is a flowchart illustrating a control method of the input current of a charger after the start of charge according to the embodiment of the present invention;

FIG. 12 illustrates a control for decreasing the input current of the charger after the start of charge according to the embodiment of the present invention;

FIG. 13 illustrates a control for increasing the input current of the charger after the start of charge according to the embodiment of the present invention; and

FIG. 14 illustrates the relationship between an input voltage and an input current in a method of finding the relationship between the input voltage and the input current as a first-order approximation straight line according to the embodiment of the present invention.

### DESCRIPTION OF EMBODIMENTS

Hereinafter, embodiments of the present invention will be described in detail with reference to the accompanying drawings.

### Embodiments

### Configuration of Charging System

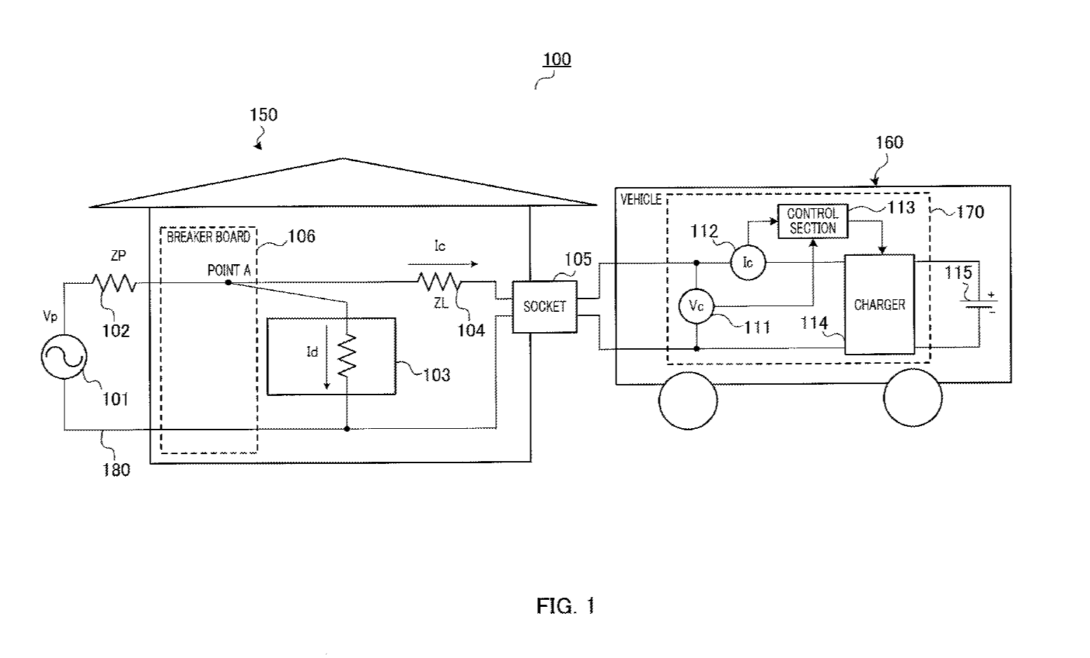

FIG. 1 illustrates a configuration of charging system 100 according to an embodiment of the present invention.

House 150 is a house of the owner of vehicle 160, for example. House 150 includes socket 105 connected to in-vehicle charging apparatus 170 of vehicle 160. House 150 has power supply circuit 180 that supplies a power supply current from power source 101. House 150 includes breaker board 106 that shuts off power supply circuit 180 when an overcurrent flows through power supply circuit 180.

Vehicle 160 charges storage battery 115 installed in vehicle 160, by in-vehicle charging apparatus 170 connected to socket 105, using power source 101 supplied to the inside of house 150 from, for example, a power plant. Vehicle 160 is an electric vehicle which runs using storage battery 115 as a driving source.

In-vehicle charging apparatus 170 charges storage battery 115 installed in vehicle 160. A configuration of in-vehicle charging apparatus 170 will be described below in detail.

Power supply circuit 180 includes power source 101, output impedance 102 of power source 101, and impedance 104 of the wiring which connects power source 101 and charger 114. Power supply circuit 180 is a circuit for supplying a power source from power source 101 to electric device 103 or in-vehicle charging apparatus 170.

### Configuration of In-Vehicle Charging Apparatus

In-vehicle charging apparatus 170 has voltage measurement section 111, current measurement section 112, control section 113, and charger 114.

Voltage measurement section 111 measures the input voltage of charger 114 and outputs the measured voltage value to control section 113.

Current measurement section 112 measures the input current of charger 114 corresponding to the input voltage of charger 114 and outputs the measured current value to control section 113.

Control section 113 acquires the input voltage of charger 114 measured a plurality of times by voltage measurement section 111 during the stop of charge, and determines the lower limit threshold of the proper range of the input voltages from the acquired input voltages. Here, the term “during the stop of charge” refers to the state where the input current of charger 114 is set to “substantially 0” (no load) (Ic=0). Control section 113 finds for the relationship between the plurality of measured voltage values inputted from voltage measurement section 111 and the plurality of measured current values corresponding to the plurality of respective measured voltage values inputted from current measurement section 112 as a first-order approximation straight line, and stores the found values as a table. Control section 113 performs a control that decreases the input current when the input voltage decreases, according to the lower limit threshold and the table of the first-order approximation straight line after the start of charge. A method of determining a lower limit threshold and a control method of the input current after the start of charge will be described below.

Charger 114 charges storage battery 115 with an input current controlled by control section 113, using power source 101.

### How to Determine Lower Limit Threshold

Lower limit threshold Vkmin is a lower limit value of voltage Vk at point A of breaker board 106, and is a parameter used with a first-order approximation straight line in order to control an input current so that no overcurrent flows in power supply circuit 180 when the use of electric device 103 is started after the start of charge for storage battery 115. When input voltage Vc is equal to or less than the lower limit threshold, a control that decreases input current Ic is performed. On the other hand, when input voltage Vc is equal to or more than the lower limit threshold, a control that increases input current Ic is performed. The relationship between this current control and the first-order approximation straight line will be described below.

The relationship between input voltage Vc and first-order approximation straight line Vk is represented by Equation 1. Equation 1 leads to Vc≈Vk when input current Ic is substantially equal to 0.

[1]

Vc=Vk−Zs*Ic (Equation 1)
where Vc is the input voltage of charger 114,
Vk is the intercept of the first-order approximation straight line,
Zs is the synthetic impedance of the output impedance of power source 101 and the impedance of wiring between power source 101 and charger 114, and
Ic is the input current of charger 114.

Lower limit threshold Vkmin is determined by the following method based on the intercept of the first-order approximation straight line.

### First Method

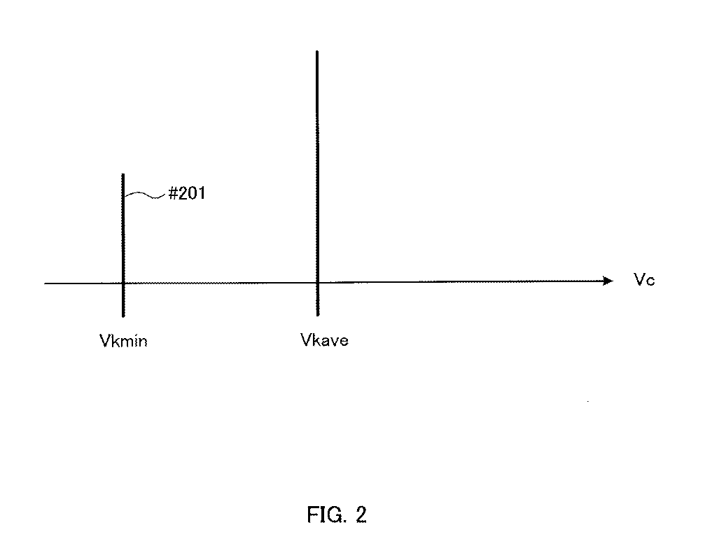

FIG. 2 illustrates the firs method of determining a lower limit threshold.

In the first method, control section 113 sets, as lower limit threshold Vkmin, minimum value #201 until the measurement time of intercept Vk of the first-order approximation straight line obtained from input voltage Vc and input current Ic that are measured a plurality of times in voltage measurement section 111 during the stop of charge. In FIG. 2, Vkave is the average value of voltage Vk at point A obtained from the average value of input voltage Vc measured a plurality of times in voltage measurement section 111.

The first method simply sets minimum value #201 as lower limit threshold Vkmin and can therefore reduce the processing load for determining lower limit threshold Vkmin.

### Second Method

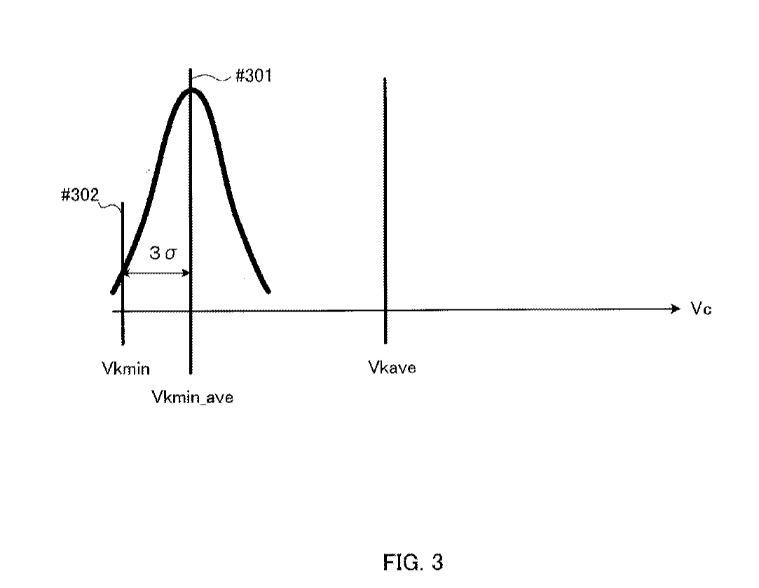

FIG. 3 illustrates the second method of determining a lower limit threshold.

In the second method, control section 113 finds average value #301 (Vkmin_ave) of minimum values of intercepts Vk of respective first-order approximation straight lines obtained from input voltage Vc measured a plurality of times in voltage measurement section 111 during the stop of charge and sets, as lower limit threshold Vkmin, value #302 lower than found average value #301 by a predetermined deviation (for example, 3σ). In FIG. 3, Vkave is the average value of intercepts Vk of the first-order approximation straight lines obtained from input voltage Vc measured a plurality of times in voltage measurement section 111.

The second method sets, to lower limit threshold Vkmin, a value lower than average value #301 of the plurality of minimum values of intercepts Vk of the first-order approximation straight lines by the predetermined deviation and can therefore improve the reliability of lower limit threshold Vkmin.

### Third Method

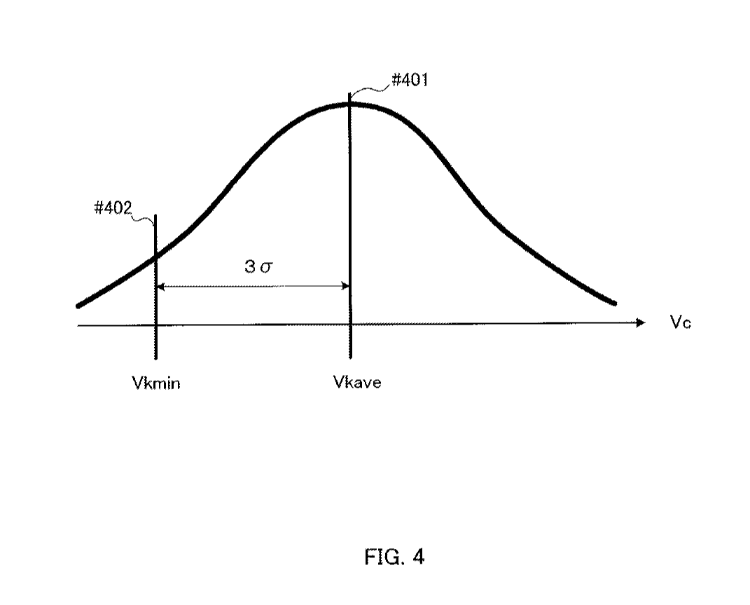

FIG. 4 illustrates the third method of determining a lower limit threshold.

In the third method, control section 113 sets, as lower limit threshold Vkmin, value #402 lower than average value #401 of input voltage Vc measured a plurality of times in voltage measurement section 111 during the stop of charge by predetermined deviation (for example, 3σ).

The third method can determine lower limit threshold Vkmin based on average value #401 of the input voltage to thereby set lower limit threshold Vkmin at a higher level. As a result, when the input voltage decreases, the input current can be reduced early to secure high safety.

### Fourth Method

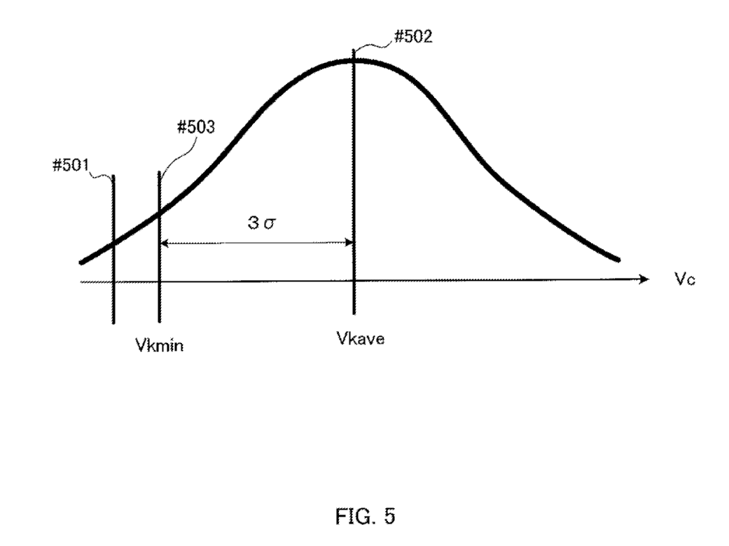

FIG. 5 illustrates the fourth method of determining a lower limit threshold.

In the fourth method, control section 113 finds minimum value #501 of input voltage Vc measured a plurality of times in voltage measurement section 111 during the stop of charge. Additionally, control section 113 finds value #503 lower than average value #502 of input voltage measured a plurality of times in voltage measurement section 111 during the stop of charge by a predetermined deviation (for example, 3σ). Control section 113 compares minimum value #501 and value #503 to set higher value #503 as lower limit threshold Vkmin.

### Fifth Method

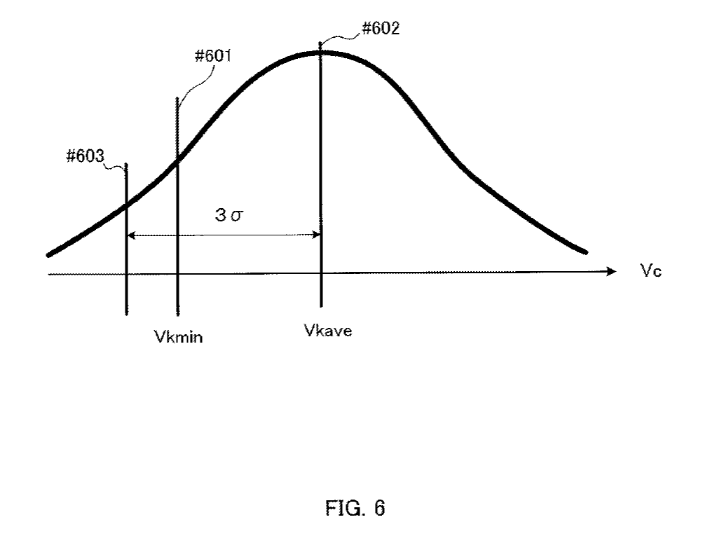

FIG. 6 illustrates the fifth method of determining a lower limit threshold.

In the fifth method, control section 113 finds minimum value #601 of input voltage Vc measured a plurality of times in voltage measurement section 111 during the stop of charge. Additionally, control section 113 finds value #603 lower than average value #602 of input voltage measured a plurality of times in voltage measurement section 111 during the stop of charge by a predetermined deviation (for example, 3σ). Control section 113 compares minimum value #601 and value #603 to set higher minimum value #601 as lower limit threshold Vkmin.

### Sixth Method

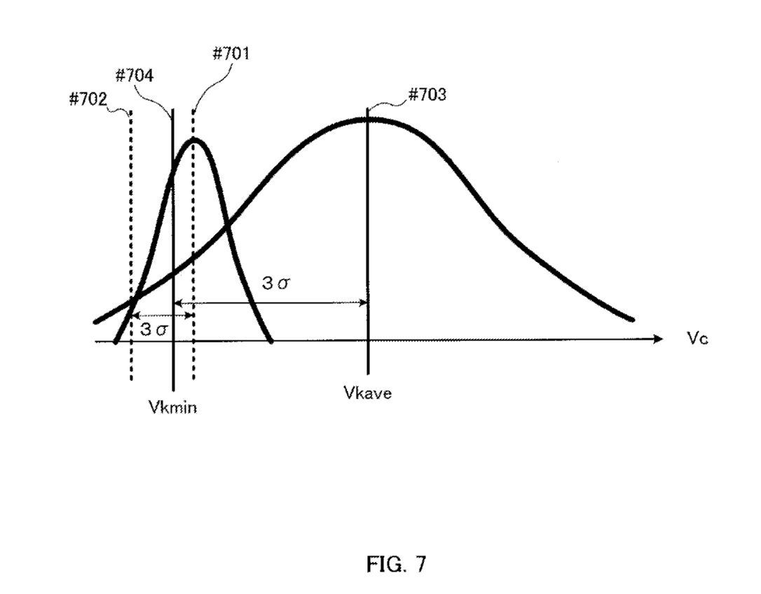

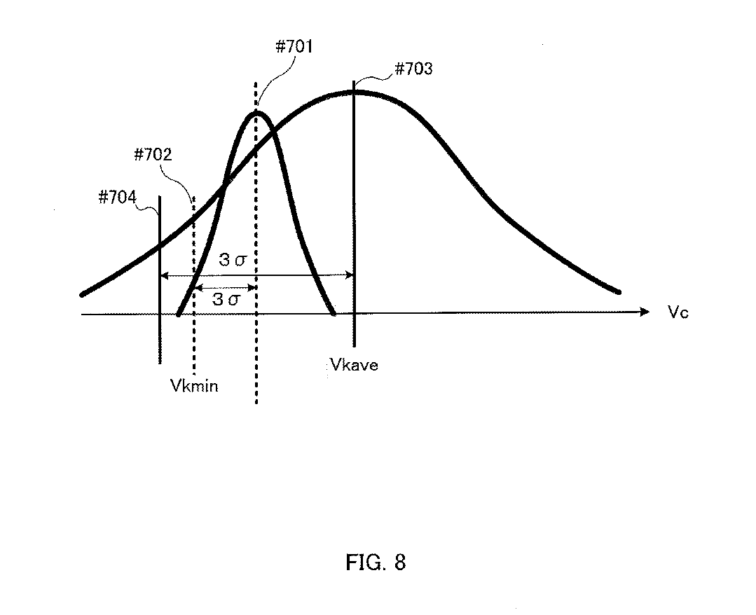

FIG. 7 illustrates an example of the sixth method of determining a lower limit threshold. FIG. 8 illustrates another example of the sixth method of determining a lower limit threshold.

In the sixth method, control section 113 finds value #702 lower than average value #701 of minimum values of input voltage Vc measured a plurality of times in voltage measurement section 111 during the stop of charge by a predetermined deviation (for example, 3σ). Additionally, control section 113 finds value #704 lower than average value #703 of input voltage measured a plurality of times in voltage measurement section 111 during the stop of charge by a predetermined deviation (for example, 3σ).

Control section 113 compares value #702 and value #704 to set the higher value as lower limit threshold Vkmin. Specifically, value #704 is set as lower limit threshold Vkmin in the case of FIG. 7, and value #702 is set as lower limit threshold Vkmin in the case of FIG. 8.

The fourth to sixth methods set, as lower limit threshold Vkmin, the higher value of the values found by two different methods, and can therefore set a suitable lower limit threshold and secure high safety.

Alternatively, as a modification of the sixth method, lower limit threshold Vkmin can be set to the larger value of the lower limit thresholds found by any two methods of the first to third methods. Combining a plurality of methods can more accurately consider the fluctuation range of the output voltage of the power source.

### Seventh Method

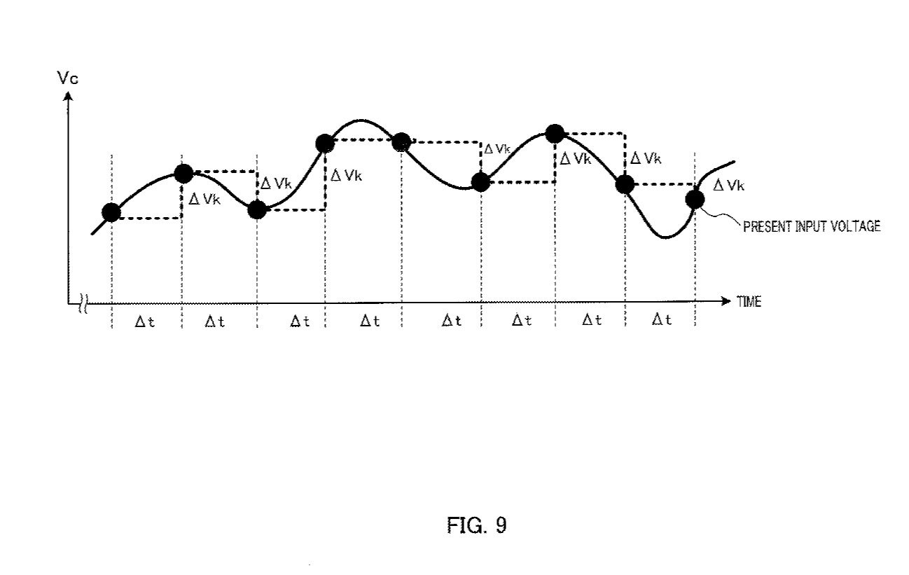

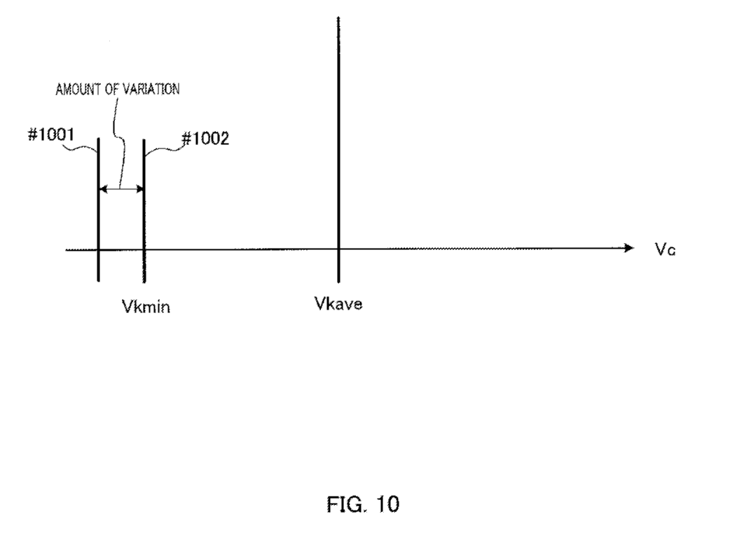

FIG. 9 illustrates a method of finding the amount of variation in the input voltage measured by voltage measurement section 111. FIG. 10 illustrates the seventh method of determining a lower limit threshold.

In the seventh method, control section 113 calculates the amount of variation (ΔVk) of input voltage Vc measured by voltage measurement section 111 for every predetermined time (Δt). Control section 113 averages the absolute values of the results to thereby find the entire amount of the variation, and sets, as lower limit threshold Vkmin, a value (#1002) higher than provisional threshold #1001 determined by any one method of the first to sixth methods by the entire amount of the variation. In FIG. 10, Vkave is the average value of input voltage measured a plurality of times in voltage measurement section 111.

The seventh method can provide a margin corresponding to the amount of the variation and further secure safety in comparison with the first to sixth methods.

### Control Method of Input Current of Charger During Charge

When the amount of power used for electric device 103 in house 150 increases during the charge of in-vehicle charging apparatus 170, the input voltage to charger 114 declines as a result. In this case, the control is performed as follows.

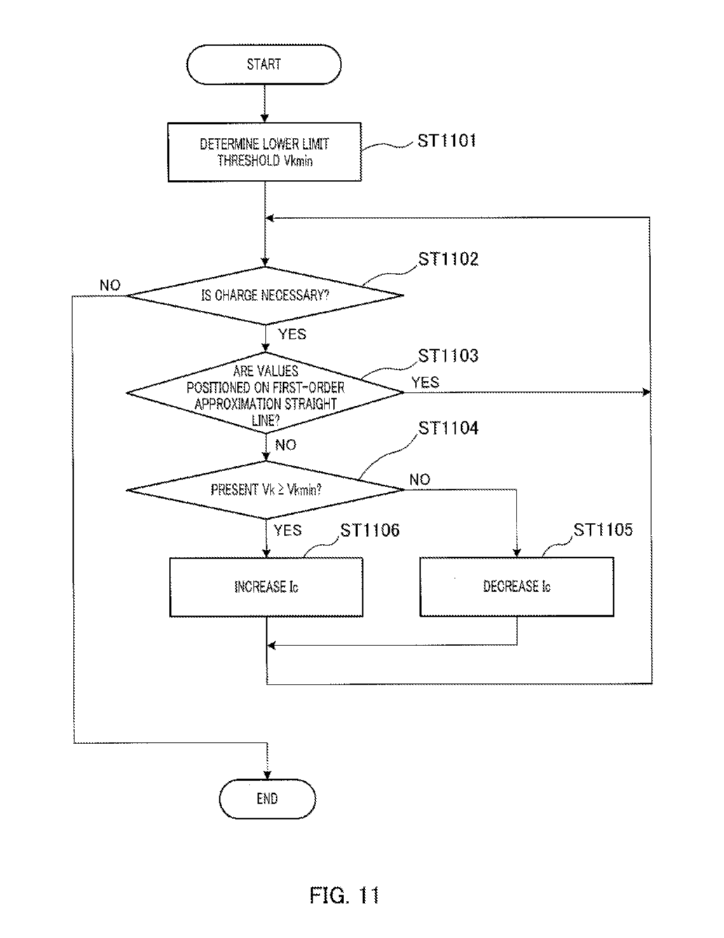

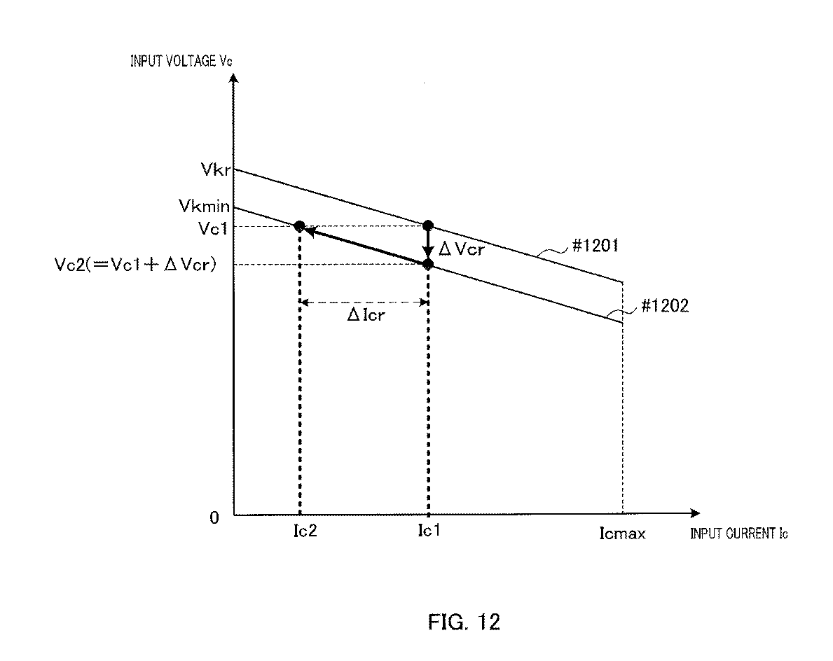

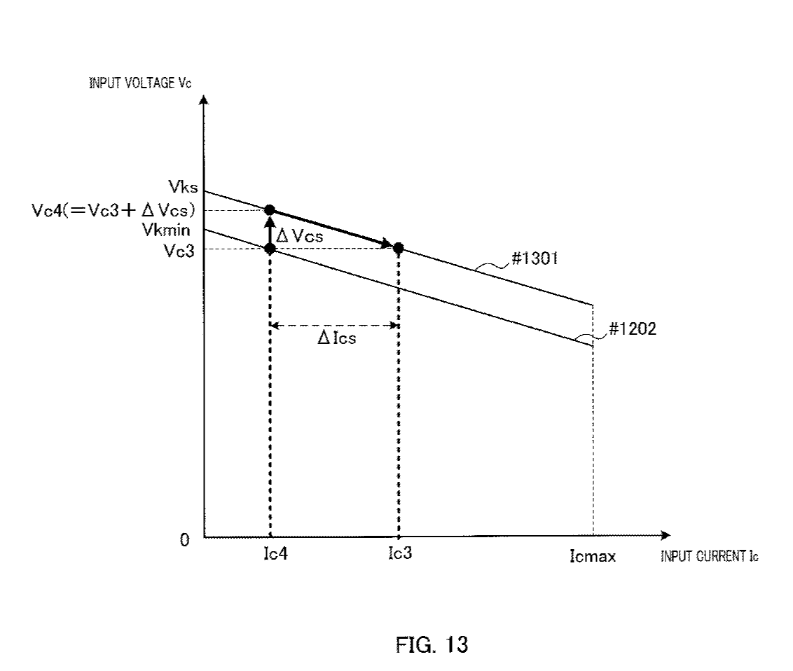

FIG. 11 is a flowchart illustrating a control method of the input current of charger 114 after the start of charge. FIG. 12 illustrates a control for decreasing the input current of charger 114 after the start of charge. FIG. 13 illustrates a control for increasing the input current of charger 114 after the start of charge.

In FIG. 12, Vc1 is the input voltage before the decrease, Vc2 is the input voltage after the decrease, Ic1 is the input current before the decrease, and Ic2 is the input current after the decrease. ΔVcr is a voltage reduction caused by an increase in load current Id flowing through electric device 103. ΔIcr is a current decreased by the control of control section 113. Vkr is the value of input voltage Vc at the intersection of first-order approximation straight line #1201 and the vertical axis.

In FIG. 13, Vc3 is the input voltage before the increase, Vc4 is the input voltage after the increase, Ic3 is the input current after the increase, and Ic4 is the input current before the increase. ΔVcs is a voltage rise caused by a decrease in load current Id flowing through electric device 103. ΔIcs is a current increased by the control of control section 113. Vks is the value of input voltage Vc at the intersection of control straight line #1301 and the vertical axis.

Control section 113 controls the input current of charger 114 using first-order approximation straight line #1201 beforehand found after the start of charge. A method of finding first-order approximation straight line #1201 will be described below.

First, control section 113 determines lower limit threshold Vkmin by the method described above (Step ST1101).

Next, control section 113 acquires the measured value of input voltage Vc from voltage measurement section 111 and also acquires the measured value of input current Ic from current measurement section 112.

Control section 113 determines whether the charge is necessary (Step ST1102). For example, control section 113 determines that the charge is unnecessary when storage battery 115 is fully charged, and determines that the charge is necessary when storage battery 115 is not fully charged.

When it is determined that the charge is unnecessary (Step ST1102: NO), control section 113 completes the process.

On the other hand, when it is determined that the charge is necessary (Step ST1102: YES), control section 113 determines whether the acquired measured value of the input voltage and the acquired measured value of the input current are positioned on first-order approximation straight line #1201 (Step ST1103).

When the input voltage is stable and the values are positioned on first-order approximation straight line #1201 (Step ST1103: YES), an overcurrent does not flow through the power supply circuit even if the input current of charger 114 is not adjusted. Control section 113 therefore continues the charge with the unvaried input current.

On the other hand, when the values are not positioned on first-order approximation straight line #1201 (Step ST1103: NO), control section 113 determine whether present input voltage Vk for Ic=0 is equal to or more than lower limit threshold Vkmin (Step ST1104).

Specifically, since input current Ic=0 is not satisfied after the start of charge, first-order approximation straight line #1201 is used to determine whether present input voltage Vk is equal to or more than lower limit threshold Vkmin. That is, control section 113 finds control straight line #1202 having the same slope as that of first-order approximation straight line #1201 and an intercept equal to lower limit threshold Vkmin, and determines whether an input voltage undergoing the voltage reduction (ΔVc) is equal to or more than control straight line #1202, assuming that input current Ic is constant (Ic=Ic1).

When input voltage Vc is less than lower limit threshold Vkmin (when an input voltage undergoing the voltage reduction is less than control straight line #1202)(Step ST1104: NO), control section 113 controls charger 114 according to control straight line #1202 so as to decrease input current Icr (Step ST1105).

Specifically, as illustrated in FIG. 12, when input voltage Vc decreases from Vc1 to a value less than Vc2, charger 114 is controlled so as to decrease input current from Ic1 so that the input voltage on control straight line #1202 having an intercept equal to lower limit threshold Vkmin is substantially equal to input voltage Vc1 before the decrease. Here, input voltage Vc substantially equal to input voltage Vc1 is equal to or more than input voltage Vc1 and equal to or less than a value larger than input voltage Vc by predetermined value α (where α>0) (Vc1≦Vc≦(Vc1+α)). This is a concept including a control for decreasing input current from Ic1 to an input current corresponding to a voltage higher than input voltage Vc1 before the decrease by predetermined value α.

On the other hand, when input voltage Vc is equal to or more than lower limit threshold Vkmin (when an input voltage undergoing the voltage reduction is equal to or more than control straight line #1202)(Step ST1104: YES), control section 113 controls charger 114 so as to increase input current Ic (Step ST1106).

Specifically, as illustrated in FIG. 13, assuming that input current Ic is constant when input voltage Vc increases from a value equal to or less than Vc3 to Vc4, control straight line #1301 is found which has the same slope as that of control straight line #1202 and passes through input voltage Vc4 after the increase. Control section 113 controls charger 114 so as to increase the input current from Ic4 so that the input voltage on found control straight line #1301 is substantially equal to input voltage Vc3 before the increase. However, at this time, control section 113 controls the input current so as not to be equal to or more than maximum allowable current value Icmax. Here, input voltage Vc substantially equal to input voltage Vc3 is equal to or less than input voltage Vc3 and equal to or more than a value smaller than input voltage Vc by predetermined value β (where β>0) (Vc3≧Vc≧(Vc3−β)). This is a concept including a control for increasing the input current from Ic4 to an input current corresponding to a voltage lower than input voltage Vc3 before the increase by predetermined value β.

Alternatively, in FIG. 11, processing in Step ST1101 of determining the lower limit threshold may be performed after Step ST1102 of determining whether the charge is necessary is performed, and the charge is determined to be necessary.

### Specific Example Control on Input Current Ic

With reference to FIG. 12, an example case will be described in which in-vehicle charging apparatus 170 starts the charge for storage battery 115 using power source 101 when electric device 103 is stopped, and then electric device 103 starts to operate by receiving a power source from power source 101.

Voltage reduction ΔVc up to control straight line #1202 caused by the start of operation of electric device 103 can be found by Equation 2.

[2]

ΔVc=−ZP*ΔId (Equation 2)
where Id is a current flowing through electric device 103, and
ZP is the output impedance of power source 101.

Control section 113 decreases input current Ic to compensate the influence of voltage reduction ΔVc found from Equation 2.

Here, input voltage Vc can be found by Equation 3.

[3]

Vc=Vp·ZP(Ic+Id)−ZL*Ic (Equation 3)
where Vp is the voltage of power source 101,
Ic is a current flowing from point A (refer to FIG. 1) of breaker board 106 to charger 114,
Id is a current flowing through electric device 103,
ZP is the output impedance of power source 101, and
ZL is the impedance of wiring between power source 101 and charger 114.

Equation 3 is deformed to give input voltage Vc by Equation 4.

[4]

Vc=(Vp−ZP*Id)−ZS*Ic (Equation 4)
where Zs is the synthetic impedance of ZP and ZL.

Output voltage Vk of breaker board 106 for input current Ic=0 can be found by Equation 5.

[5]

Vk=Vp−ZP*Id (Equation 5)
where Vp is the voltage of power source 101,
Id is a current flowing through electric device 103, and
ZP is the output impedance of power source 101.

Equation 5 is substituted for Equation 4 to obtain Equation 1.

From Equation 1, input voltage Vc1 before the decrease and input voltage Vc2 after the decrease are obtained by Equations 6 and 7, respectively.

[6]

Vc1=Vk−ZS*Ic1 (Equation 6)

[7]

Vc2=Vk−ZS*Ic2 (Equation 7)

Since voltage reduction ΔVc=Vc2−Vc1, Equation 6 is subtracted from Equation 7 to thereby obtain voltage reduction ΔVc by Equation 8.

[8]

ΔVc=−ZS*ΔIc (Equation 8)

Equation 8 can be deformed to thereby obtain Equation 9.

[9]

ΔIc=−ΔVc/ZS (Equation 9)

Therefore, decrease amount ΔIc of input current Ic compensating the influence of voltage reduction ΔVc can be found by Equation 9.

Here, Equation 1 is substituted for Equation 9 to thereby obtain Equation 10.

[10]

ΔId=−(ZS/ZP)*ΔIc (Equation 10)

From Equation 10, since (ZS/ZP)≧1, ΔIc≦ΔId. Therefore, a decrease amount of ΔIc can be obtained corresponding to an increase in ΔId, and an increase amount of ΔIc can be obtained corresponding to a decrease in ΔId.

### How to Find First-Order Approximation Straight Line

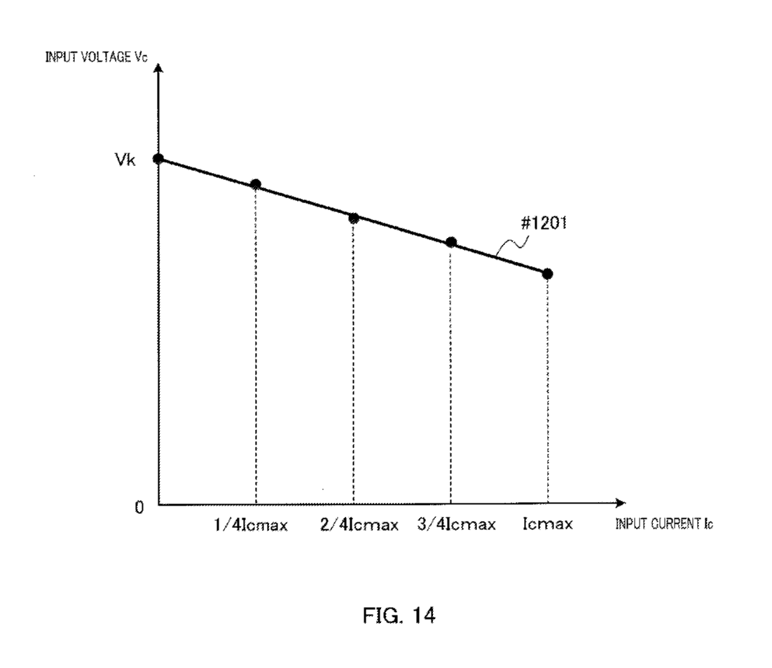

FIG. 14 illustrates the relationship between an input voltage and an input current in a method of finding the relationship between the input voltage and the input current as first-order approximation straight line #1201.

Control section 113 finds first-order approximation straight line #1201, for example, before the start of charge.

Control section 113 varies input current Ic in sequence at predetermined time intervals and acquires the measured value of input voltage Vc at every timing of the varying. For example, as illustrated in FIG. 14, control section 113 varies input current Ic in sequence in order of “0”, “¼Icmax”, “ 2/4Icmax”, “¾Icmax”, and “Icmax”, and acquires the measured value of each input voltage Vc. Input current Ic and input voltage Vc which are acquired are associated and stored as a table.

As illustrated in FIG. 14, control section 113 finds the relationship between the value of each varied input current Ic and the measured value of each input voltage Vc corresponding to each input current Ic, as first-order approximation straight line #1201. First-order approximation straight line #1201 is found, for example, by the least-squares method. The method of finding first-order approximation straight line #1201 is not to the least-squares method, but any other appropriate methods can be used.

The slope of first-order approximation straight line #1201 is equal to synthetic impedance Zs (Zs=ZP+ZL) obtained by synthesizing output impedance ZP of power source 101 and impedance ZL of the wiring between power source 101 and charger 114.

### Advantageous Effects of Present Embodiment

As described above, according to the present embodiment, the input current of the in-vehicle charger is controlled in consideration of the fluctuation range of the output voltage of the power source. Thereby, even if an unstable power source is used for the charge, is possible to prevent an in-vehicle charger from becoming unable to perform charge and also to prevent an unusable state of another electric device in a house or the like.

According to the present embodiment, only an input current compensating the influence of the voltage reduction up to the lower limit threshold is reduced when the voltage reduction of the input voltage is caused by the use of another electric device during the charge. This configuration enables charging with a maximum input current that can be used for charging.

### Variations of Present Embodiment

In the above-described embodiment, a control that decreases the input current of charger 114 by a single level is performed. However, the present invention is not limited to this configuration, and a control that decreases the input current of charger 114 by a plurality of levels may be performed.

In the above-described embodiment, Vkmin, Vkave, deviation 3σ, or the like is calculated during the stop of charge. However, the present invention is neat limited to this configuration, and Vkmin, Vkave, and deviation 3σ, or the like may be continuously calculated after the start of charge (during charge). This configuration enables a control in consideration of the fluctuation of the output voltage of the power source during the charge.

In the above-described embodiment, first-order approximation straight line is found before the start of charge, and the input current of the charger is controlled according to the first-order approximation straight line after the start of the charge. However, the present invention is not limited to this configuration, and a first-order approximation straight line may be found at predetermined timing after the start of charge.

In the above-described embodiment, when breaker board 106 shuts off power supply circuit 180 to shut off the supply of the power source from power source 101 to storage battery 115 during a process of varying input current Ic in sequence, control section 113 can store Ic that is the largest during the time when the supply of the power source is not shut off. In order to find a first-order approximation straight line next time, Ic can be varied in sequence using this stored Ic as the maximum value to calculate the first-order approximation straight line.

This configuration can decrease a possibility that power supply circuit 180 is shut off by breaker board 106 during varying of Ic in sequence due to a low supply capacity of power source 101.

In the above-mentioned embodiment, in order to charge storage battery 115, control section 113 can set maximum allowable current value Icmax as Ic that is the largest value stored for finding a first-order approximation straight line and adjust input current Ic in the range not exceeding the largest value.

This configuration can decrease a possibility that power supply circuit 180 is shut off by breaker board 106 during varying of input current Ic due to a low power source supply capacity of power source 101.

The disclosure of Japanese Patent Application No. 2011-76124, filed on Mar. 30, 2011, including the specification, drawings and abstract, is incorporated herein by reference in its entirety.

### INDUSTRIAL APPLICABILITY

An in-vehicle charging apparatus according to the present invention is suitable for charging a storage battery serving as the power source of a vehicle such as an electric vehicle, using the power supply of a house, for example.

### REFERENCE SIGNS LIST

100 Charging system
101 Power source
102 Output impedance
103 Electric device
104 Impedance
105 Socket
106 Breaker board
111 Voltage measurement section
112 Current measurement section
113 Control section
114 Charger
115 Storage battery
150 House
160 Vehicle
170 In-vehicle charging apparatus
180 Power supply circuit

1-11. (canceled)

12. An in-vehicle charging apparatus that charges a storage battery installed in a vehicle from an power source provided outside the vehicle, the apparatus comprising:
a charger that is connected to the power source provided outside the vehicle and that receives a variable input current for charging the storage battery;
a measurement section that measures the input current of the charger and an input voltage corresponding to the input current; and
a control section that varies the input current of the charger into a plurality of values, determines a lower limit threshold of a proper range of the input voltage according to a correspondence between the input currents during the varying and the input voltages measured by the measurement section, and controls the input current according to the correspondence and the lower limit threshold.

13. The in-vehicle charging apparatus according to claim 12, wherein the control section finds the correspondence as a first-order approximation straight line, determines the lower limit threshold based on an intercept of the first-order approximation straight line, and controls the input current according to the first-order approximation straight line and the lower limit threshold.

14. The in-vehicle charging apparatus according to claim 13, wherein the control section finds a control straight line that has the same slope as the first-order approximation straight line and passes through the lower limit threshold with respect to the input voltage after start of charge, performs a control that decreases the input current down to an input current corresponding to an input voltage substantially equal to the input voltage before a decrease on the control straight line, and performs, when the input voltage increases after start of charge, a control that increases the input current up to an input current corresponding to an input voltage that corresponds to the same slope as that of the first-order approximation straight line and that is substantially equal to the input voltage before the increase.

15. The in-vehicle charging apparatus according to claim 13, wherein the control section sets a minimum value of intercepts of the first-order approximation straight line measured a plurality of times until measurement time, as the lower limit threshold.

16. The in-vehicle charging apparatus according to claim 13, wherein the control section finds a minimum value of intercepts of the first-order approximation straight line measured a predetermined number of times for every predetermined number of the times, finds an average value of the found minimum values, and sets a value smaller than the average value by a predetermined deviation, as the lower limit threshold.

17. The in-vehicle charging apparatus according to claim 13, wherein the control section sets a value smaller than an average value of intercepts of the first-order approximation straight line measured a plurality of times, by a predetermined deviation, as the lower limit threshold.

18. The in-vehicle charging apparatus according to claim 13, wherein the control section finds amounts of variation of intercepts of the first-order approximation straight line measured a plurality of times, sets an average value of the amounts of the variation, as a provisional threshold, and sets a value larger than the lower limit threshold by the provisional threshold, a new lower limit threshold.

19. The in-vehicle charging apparatus according to claim 13, wherein:
the control section calculates at least two values of:
a minimum value until measurement time of intercepts of the first-order approximation straight line measured a plurality of times;
a value smaller than an average value by a predetermined deviation, the average value being obtained by finding a minimum value of intercepts of the first-order approximation straight line measured a predetermined number of times for every predetermined number of the times and averaging the found minimum values; and
a value smaller than an average value of intercepts of the first-order approximation straight line measured a plurality of times by a predetermined deviation; and
the control section sets a larger value of the two values as the lower limit threshold.

20. The in-vehicle charging apparatus according to claim 12, wherein the control section finds, when the supply of the power source to the storage battery from the power source provided outside the vehicle is shut off in a process of finding the correspondence, the correspondence based on an input current equal to or less than a largest value among input currents set before the shutoff when the correspondence is found next time.

21. The in-vehicle charging apparatus according to claim 12, wherein the control section determines the lower limit threshold according to the correspondence at least before or after start of charge.

22. The in-vehicle charging apparatus according to claim 12, wherein the control section controls the input current according to the correspondence and the lower limit threshold when the input voltage varies after start of charge.
